(19) United States
(12) Patent Application Publication
(10) Pub. No.: US 2005/0083171 A1
(43) Pub. Date: Apr. 21, 2005

(54) SECURITY SYSTEMS

(76) Inventor: Sharon Hamilton, Aurora, CO (US)

Correspondence Address: GLENN L. WEBB, P.O BOX 951, CONIFER, CO, 80433, US

(21) Appl. No.: 10/904,363

(22) Filed: Nov. 5, 2004

Related U.S. Application Data
(63) Continuation of application No. 10/016,664, filed on Dec. 10, 2001, now abandoned.

(51) Int. Cl. H04B 1/00

(52) U.S. Cl. 340/5.7; 340/572.1

(57) ABSTRACT

A security system includes machine readable passenger and employee wrist bracelets and baggage tags in conjunction with a computerized control system, electrically remotely actuated locks, alarms, and communications links to monitor and control the movement of passengers, employees, and baggage. The system prevents security breaches through lost security badges, misplaced keys, or access codes being given to or obtained by unauthorized individuals, and may include double doors having remotely actuated locks to selectively detain unauthorized individuals between a pair of locked double doors. The wrist bracelets and baggage tags are preferably constructed so as to be difficult to remove and may include electronic circuitry to provide an indication of tampering or removal. The system preferably includes a database associated with at least one data display and input terminal to maintain information pertaining to flight data, passenger data, employee data, baggage data, and facility data. The system may employ a relational type of database structure to provide convenient access to all types of data pertaining to a particular individual, flight, bag, or facility. The system may include GPS sensors to enable current real time display of status and location information associated with a particular bag, flight, or individual.

### RELATED APPLICATIONS

This application is a continuation in part of Ser. No. 10/016,664, filed on Dec. 10, 2001, pending.

### FIELD OF THE INVENTION

The present invention is directed to the field of security systems, and more particularly pertains to a security system for tracking and monitoring airport passengers and their baggage as well as corporate security.

### BACKGROUND OF THE INVENTION

Security in the field of travel in general, and particularly within airports and airlines is a critical issue. The ease of access of unauthorized individuals within airports and to airline craft is of great concern. The viability of typical increased security in airports, trains, and other mass transport systems is of concern, particularly when measured against the expense, time consumption and discomfort of travelers and employees. Also, the ability to carry-on items onto airliners is counterbalanced between the comfort of the traveler and the security of the airliner and its passengers.

The field of travel and airport security in general, and the field of passenger and baggage tracking security systems in particular, is relatively crowded. Representative examples of such systems can be found in the following patents: U.S. Pat. No. 5,401,944, issued Mar. 28, 1995 to Bravman et al.; U.S. Pat. No. 5,600,303, issued Feb. 4, 1997 to Husseiny et al., U.S. Pat. No. 5,608,382, issued Mar. 4, 1997 to Webb et al.; U.S. Pat. No. 5,648,765, issued Jul. 15, 1997 to Cresap et al.; U.S. Pat. No. 5,692,029, issued Nov. 25, 1997 to Husseiny et al.; U.S. Pat. No. 5,815,467, issued Sep. 29, 1998 to Deering; U.S. Pat. No. 5,866,888, issued Feb. 2, 1999 to Bravman et al.; U.S. Pat. No. 5,914,671, issued Jun. 22, 1999 to Tuttle; U.S. Pat. No. 5,933,098, issued Aug. 3, 1999, to Haxton; U.S. Pat. No. 6,119,096, issued Sep. 12, 2000 to Mann et al.; U.S. Pat. No. 6,127,917, issued Oct. 3, 2000 to Tuttle; U.S. Pat. No. 6,211,790 B1, issued Apr. 3, 2001 to Radomsky et al.; U.S. Pat. No. 6,222,452 B1, issued Apr. 24, 2001 to Ahistrom. The entire disclosure of each of the foregoing patents is hereby incorporated herein by this reference.

Security systems including double doors operating according to associated control systems for detaining unauthorized individuals between two sets of doors are disclosed in U.S. Pat. No. 4,481,887, issued Nov. 13, 1984 to Urbano; U.S. Pat. No. 5,992,094, issued Nov. 30, 1995 to Diaz; and U.S. Pat. No. 6,298,603 B1, issued Oct. 9, 2001 to Diaz. The entire disclosure of each of the foregoing patents is hereby incorporated herein by this reference.

### SUMMARY OF THE INVENTION

An airport security system according to the present invention includes machine readable passenger and employee wrist bracelets and baggage tags in conjunction with a computerized control system, electrically remotely actuated locks, alarms, and communications links to monitor and control the movement of passengers, employees, and baggage. The system prevents security breaches through lost security badges, misplaced keys, or access codes being given to or obtained by unauthorized individuals, and may include double doors having remotely actuated locks to selectively detain unauthorized individuals between a pair of locked double doors. The wrist bracelets and baggage tags are preferably constructed so as to be difficult to remove and may include electronic circuitry to provide an indication of tampering or removal. The system preferably includes a database associated with at least one data display and input terminal to maintain information pertaining to flight data, passenger data, employee data, baggage data, and facility data. According to one aspect of the invention, the system may employ a relational type of database structure to provide convenient access to all types of data pertaining to a particular individual, flight, bag, or facility. The system may include GPS sensors to enable current real time display of status and location information associated with a particular bag, flight, or individual.

In a preferred aspect of the invention, the security system is employed in conjunction with a security policy to preclude or limit the use of carryon items by passengers, so as to provide an enhanced measure of security and to minimize costs and delays associated with handling, storage, and security screening of carryon items.

In one preferred embodiment, the wrist bracelets or other identification devices are time sensitive to expire within a set time period, such as on a hourly, daily, or other time period. Different periods may be assigned for differing levels of security. For example, a passenger's security device may expire upon the departure of the airplane or other transportation device. An employee's security device may expire on a daily or weekly period.

In another aspect of the present invention, the database and wrist bracelet cooperate to provide personalized consumer information to enable targeted marketing of travel related goods and services to passengers. In one aspect of the invention, such targeted marketing may include a travel pack provided free or for an extra fee to passengers traveling with children, the travel pack including carrying handles, 4-6 diapers, wipes, sample size ointment, disposable bibs, a snack, and a toy. The travel pack may be customized so as to be age and sex appropriate for newborns, 4-9 month old babies, 9-18 month babies, toddlers, toddler, children, and may also include promotional sponsored offers with advertising, discount coupons, an entry to a giveaway or sweepstakes or other similar contests.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating an airport security system according to the present invention.

FIG. 2 is a block diagram illustrating a database for use in the airport security system according to the present invention.

FIG. 3 is a diagrammatic view illustrating an example travel pack which may be provided through targeted marketing to passengers using passenger data maintained by a database of the airport security system of the present invention.

### DETAILED DESCRIPTION OF PREFERRED EMBODIMENTS

The present invention provides security systems for mass transport or other areas where security is of concern for a large amount of people. A preferred embodiment of the present invention is discussed below with particular relevance to airport security. It is to be expressly understood that this descriptive embodiment is provided for explanatory purposes only and is not meant to limit the scope of the claimed invention. Other types and uses of such security systems are also considered to be within the scope of the present invention. For example, the security system of the present invention may be used for trains, buses, ships and other mass transport systems as well in buildings, campuses and other areas accessible by large numbers of people.

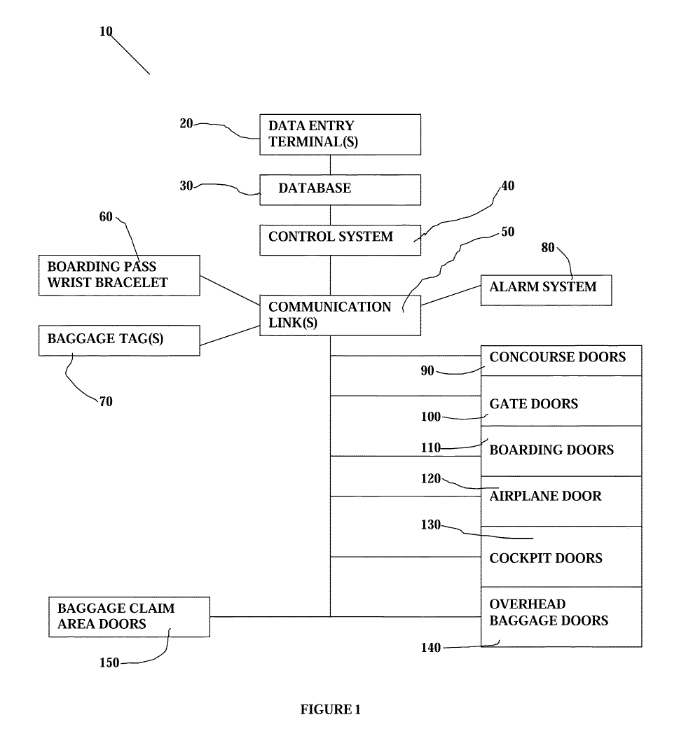

With reference now to the drawings, and in particular to FIG. 1, an airport security system 10 according to a preferred embodiment of the present invention includes at least one and preferably a plurality of data entry terminals 20 connected to a database 30. The data entry terminals preferably include a display screen and a keyboard, and may also include other data entry devices such as a mouse or joystick, a finger print scanner, a bar code reader, an optical scanner, a magnetic card strip reader, or any other conventional mechanism or device for the entry of data into a computer system. The security system 10 may be implemented in connection with a computer mainframe connected to a plurality of terminals, or may take the form of a personal computer network. In any event, the data terminals 10 provide access to at least one database 30 for the purpose of storing, retrieving, and displaying information, and also for the entry of information into the database 30. The data entry terminals 20 may take the form of stationary or portable devices, and may be connected to the system by cabling, or by wireless technologies such as radio frequency network links, satellite communications, infrared data links, or the like.

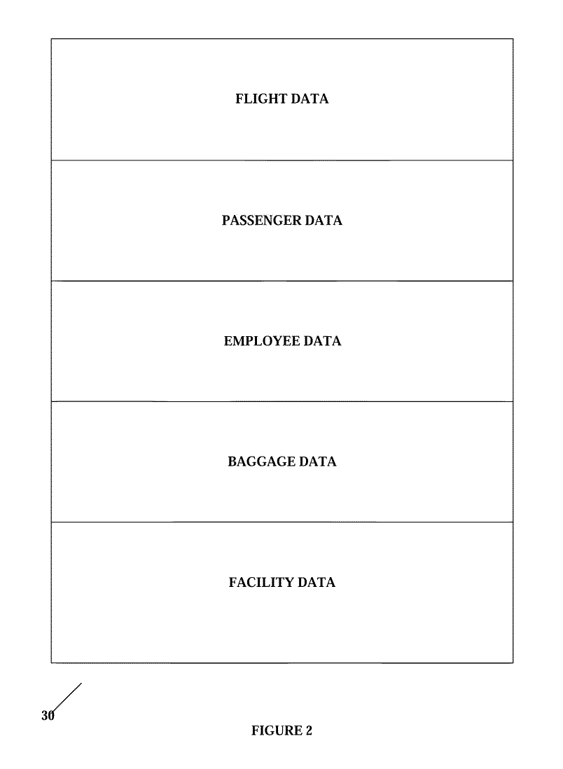

As shown in FIG. 2, the database 30 preferably includes means for storing FLIGHT DATA, PASSENGER DATA, EMPLOYEE DATA, BAGGAGE DATA, and FACILITY DATA. The types of data that may be included in each portion of the database within each category appears under the associated heading below. It is to be expressly understood that other data may be included as well or in place of these types of data.

FLIGHT DATA

flight number

current location

type of aircraft (may also include or have links to detailed aircraft log including flight log, maintenance records, fueling records, etc.)

schedule

arrival airport

departure airport

baggage claim

arrival concourse

arrival gate

departure concourse

departure gate

crew list

passenger list

baggage list (may link to baggage data)

PASSENGER DATA

name

wrist bracelet identification

current location

addresses

telephone numbers

email addresses

ticketing information (for example type of ticket, where purchased, price paid, bonus miles, etc.)

travel history records

medical history records

relatives and contact information

traveling companion information (identity, etc.)

itinerary

hotel

rental car

finger print

DNA

dental records

digital photograph

psychological profile

criminal history

physical description (height, weight, hair color, eye color, etc.)

special dietary requirements

seating preferences

special handicap accommodation (wheelchair, etc.)

(authorized flights, airports, concourses, gates, baggage claims, service vehicles, permissible doors, etc.)

EMPLOYEE DATA

name

wrist bracelet identification

current location

addresses

telephone numbers

email

DNA

finger print

digital photograph

physical description (height, weight, hair color, eye color, etc.)

work history

criminal history

psychological profile

work records

schedule

facility access

job title

job description

job number

financial records

medical records

relatives

dental records

(authorized flights, airports, concourses, gates, baggage claims, service vehicles, permissible doors, etc.)

BAGGAGE DATA

name of associated passenger (may include relational data base linkage)

baggage tag identification

physical description (size, color, type, maker, etc.)

weight

contents

current location

authorization information (authorized flights, airports, concourses, gates, baggage claims, service vehicles, permissible doors, etc.)

FACILITY DATA

name

physical description

address

telephone numbers

baggage claims

concourses

flights

doors (may include authorization information)

alarms

employees

passengers using or scheduled to use facility

flight information

fire fighting services information

medical services information

security services information

weather information

The database 30 may comprise one or more databases, which may or may not be linked, and may be relational databases providing convenient linkage between the related aspects of the FLIGHT DATA, PASSENGER DATA, EMPLOYEE DATA, BAGGAGE DATA, and FACILITY DATA, so as to provide maximum flexibility and ease of use. The database 30 may further include object oriented programming features such that the various categories of data may be displayed through graphical interfaces, rather than, or in conjunction with, text mode type data display. For example, the FACILITY DATA may provide a graphical display of a map of the airport, airplanes, and buildings, such that clicking a mouse pointer on, or otherwise selecting, one or portion of the graphical representations displayed provides further information. Such further information may take the form of a more detailed or “zoomed” type of display, or may provide a windowed linkage to related data. For example, selection of a particular graphical airplane icon appearing on an airport map may open one or more database windows showing the FLIGHT DATA, PASSENGER DATA, EMPLOYEE DATA, BAGGAGE DATA and FACILITY DATA related to the particular icon. Similarly, selecting a particular airport concourse may open one or more database windows displaying FLIGHT DATA, PASSENGER DATA, EMPLOYEE DATA, BAGGAGE DATA, and FACILITY DATA related at that particular time to that particular concourse.

The data entry terminals 20 and the database 30 are connected to a control system 40 operably connected to at least one communications link 50. The communication link 50 may utilize any known form, or combination of known forms for the communication of information including wireless infrared, microwave, radio frequency, magnetic or electromagnetic devices, or also cabled communication apparatus such as computer cabling, fiber optic cabling, telephone line modems, or the like. The control system 40 and communications link 50 may comprise separate components, or may be integrated with a mainframe or personal computer.

The present invention contemplates the use of a boarding pass wrist bracelet 60 that preferably includes means for storing individualized identification data and means for communicating such data to at least one, and preferably a plurality of remote detection devices associated with aircraft and facility doors. Optionally, the wrist bracelet 60 may include a GPS transponder so as to provide an immediate real time indication of a particular passenger's location. The means for storing individualized identification data may include labels bearing alpha, numeric, or alpha-numeric indicia, machine readable indicia such as magnetic ink, optical recognizable characters, bar code, or any combination of the foregoing types of indicia. The means for storing individualized identification data may also take the form of electromagnetic strips of the type readable by credit card readers, programmable chips, optically or electromagnetically readable computer disks, or any other known type of data storage device. As an alternative to the storage of personalized information, the wrist bracelet 60 may include a unique identification number or code that is associated with personalized identification data maintained in the database 30, rather than stored by the bracelet 60. Alternatively, a portion of the personalized identification data may be stored by the bracelet 60, with additional data stored by the database 30.

In another preferred embodiment, the wrist bracelet includes a security strip affixed within the bracelet or on the inside of the bracelet. The information on the security strip is readable by scanners, such as magnetic sensors, or other sensors that can retrieve the information without that information being easily viewable by others. Also, the information could be encoded on a Radio Frequency Identification tag that is becoming more prevalent in retail and other industries. This provides an additional measure of security without the information being viewed by unauthorized individuals.

Preferably, the wrist bracelet 60 is constructed so as to be difficult to cut and remove, such as by forming it from a reinforced material, for example a heavy grade of plastic, Kevlar, plastic reinforced by metal strands, metal, etc. In addition, or alternatively, the bracelet 60 may include a fastener or clasp that is difficult to open without a special tool or implement. Fasteners of this type are per se known, for example of the type used to secure theft deterrent tags to merchandise in retail stores. As a further mechanism to prevent its removal, the bracelet 60 preferably includes means for providing an electronic indication of removal or tampering. This may take a variety of forms within the scope of the invention. For example, the bracelet 60 may include a metal linkage the severance of which opens a circuit and provides an electronic alarm, preferably communicable over a wireless communications link. Alternatively, the bracelet 60 may include circuitry operative to detect a wearer's body temperature and operative to sound an alarm when the sensed temperature falls outside a predetermined range. Also, the bracelet will become inoperable if it is tampered with or removed.

In addition to the wrist bracelet 60, the present invention also provides one or more baggage tags 70 that preferably include means for storing individualized baggage identification data and means for communicating such data to at least one, and preferably a plurality of remote detection devices associated with aircraft and facility doors. Optionally, the baggage tag 70 may include a GPS transponder so as to provide an immediate real time indication of a particular bag's location. The means for storing individualized identification data may include labels bearing alpha, numeric, or alpha-numeric indicia, machine readable indicia such as magnetic ink, optical recognizable characters, bar code, or any combination of the foregoing types of indicia. The means for storing individualized baggage identification data may also take the form of electromagnetic strips of the type readable by credit card readers, programmable chips, optically or electromagnetically readable computer disks, or any other known type of data storage device. As an alternative to the storage of personalized information, the baggage tag 70 may include a unique identification number or code that is associated with personalized identification data maintained in the database 30, rather than stored by the tag. Alternatively, a portion of the personalized identification data may be stored by the tag 70, with additional data stored by the database 30. This allows information to be easily changed in the database as opposed to reissuing the bracelets.

As with the wrist bracelet 60, the baggage tags 70 according to the present invention may be constructed so as to be difficult to cut or remove, such as by forming it from a reinforced material, for example a heavy grade of plastic, Kevlar, plastic reinforced by metal strands, metal, etc. In addition, or alternatively, the tag 70 may include a fastener or clasp that is difficult to open without a special tool or implement. Fasteners of this type are per se known, for example of the type used to secure theft deterrent tags to merchandise in retail stores. As a further mechanism to prevent its removal, the tag 70 preferably includes means for providing an electronic indication of removal or tampering. This may take a variety of forms within the scope of the invention. For example, the tag 70 may include a metal linkage the severance of which opens a circuit and provides an electronic alarm, preferably communicable over a wireless communications link.

The airport security system according to the present invention may also include an alarm system 80 operative to initiate audible and/or visible alarms when receiving an indication of an alarm condition via the communications link 50. In this regard, the present invention may include a plurality of detectors or sensors 90, 100, 110, 120, 130, 140, and 150, associated with, respectively, CONCOURSE DOORS, GATE DOORS, BOARDING DOORS, AIRPLANE DOOR, COCKPIT DOORS, OVERHEAD BAGGAGE DOORS, and BAGGAGE CLAIM AREA DOORS, and operative to provide an indication of unauthorized opening, tampering, or attempted opening of the various respective associated doors. Each of the foregoing doors preferably include sensors for detecting the wrist bracelets 60 and/or baggage tags 70, and may also include communications links for accessing the database 30 for the purpose of verifying whether a particular individual or bag has been granted permission to unlock and/or pass through a particular door or enter a particular part of a facility. The following provides a partial exemplary listing of permissions that might be associated with particular individuals and bags. It should be noted that such permissions may be assigned individually, or preferably at least in part automatically by assigning necessary permissions to baggage and passengers to complete certain flights and pickup their baggage.

PASSENGER PERMISSIONS

access concourse

access gate

access plane

access overhead baggage storage

access seat assignment

access baggage claim area

leave baggage claim area with only associated bags

leave or enter predetermined facility areas only with associated passengers (to prevent kidnapping or loss of children, for example)

BAGGAGE PERMISSIONS

access baggage conveyor

access service vehicle

access plane, flight number

access baggage claim area

depart baggage claim area

access baggage carousel

associate with particular passenger

destination routing

automatic calculation of total weights for plane load determinations

access particular overhead baggage storage bin

EMPLOYEE PERMISSIONS

access to only particular portions of facility

access to only particular flights

access only during permitted times

verification of hours and locations worked

association only with permitted group of coworkers

access to only particular baggage claim areas

access to only particular service vehicles

AIRCRAFT PERMISSIONS

permit departure only with full and properly assigned crew

permit departure only with authorized passengers

permit departure only with authorized baggage

In addition to providing an alarm for unauthorized opening of any of the foregoing doors, the present invention may also provide an indication of an unauthorized passage of an individual or bag into a particular area. For example, if a passenger attempts entry into a concourse not associated with their scheduled flight, or if a baggage handler attempts to load a bag onto the wrong plane, service vehicle, or baggage carousel, the system may provide an appropriate alarm or condition indication dependent upon the severity of the particular event. It is contemplated that the system may be provided with suitable user selectable or programmable permissions and associations to control passengers, employees, baggage, aircraft, and facility access as desired, as illustrated by the example listing of permissions appearing above.

The security system of the present invention may also enclose means for locking and unlocking doors depending upon the coded authorization parameters of a wrist bracelet 60 or baggage tag 70. For example, solenoid or magnetically actuated door locks of a type known per se may be provided to selectively lock or unlock selected doors. As a further optional feature of the present invention, selected passages may be secured by selectively lockable and unlockable double doors, such that an unauthorized individual may be locked between two doors.

In one preferred embodiment, the wrist bracelets or other identification devices are time sensitive to expire within a set time period, such as on a hourly, daily, or other time period. Different periods may be assigned for differing levels of security. For example, a passenger's security device may expire upon the departure of the airplane or other transportation device. An employee's security device may expire on a daily or weekly period. Visitor's security devices may be assigned a defined time period. New security devices will need to be assigned once the time period expires.

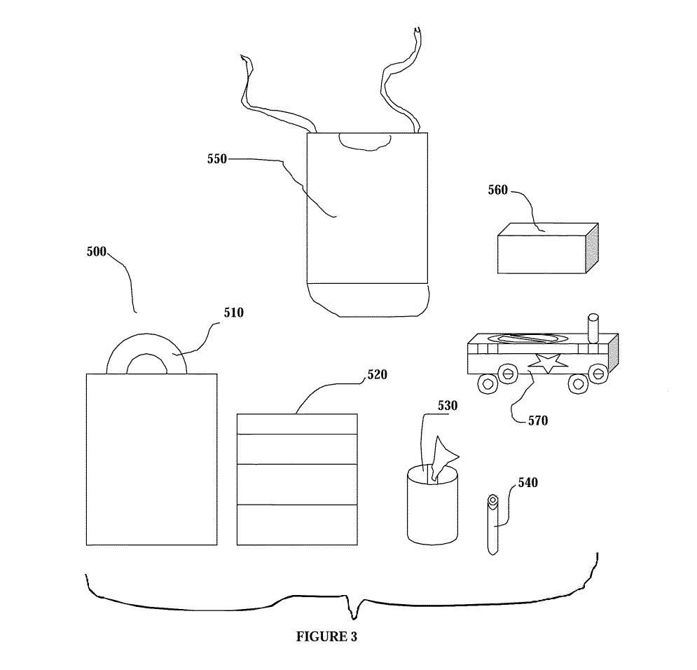

In another aspect of the present invention, the database and wrist bracelet cooperate to provide personalized consumer information to enable targeted marketing of travel related goods and services to passengers. With reference to FIG. 3, such targeted marketing may be employed to provide a travel pack 500, either free or for an extra fee, to passengers traveling with children, the travel pack including carrying handles 510, four to six diapers 520, wipes 530, sample size ointment 540, disposable bibs 550, a snack 560, and a toy 570. The travel pack 500 may be customized so as to be age and sex appropriate for newborns, 4-9 month old babies, 9-18 month babies, toddlers, toddler, children, and may also include promotional sponsored offers with advertising, discount coupons, an entry to a giveaway or sweepstakes or other similar contests.

The use of the travel pack 500, in conjunction with the airport security system of the present invention, also allows implementation of a security policy to eliminate or substantially reduce the number and size of permitted carryon items. This allows enhanced security, while at the same time obviating or eliminating delays and added costs associated with handling, storing, and security screening carryon items.

In another preferred embodiment, the security bracelet will allow passengers to travel through additional airports for connecting flights, return flights and other flights within a predetermined time frame. The information may be stored in a central database that is accessible for all airports or other transportation centers.

In another preferred embodiment, the security bracelet may allow wearers to go through express security lanes without the need for additional security frisking. Also, if the wearer is not carrying additional baggage as carry on, they will be able to quickly go through security as well.

In another preferred embodiment, the security system as described above may be adapted for use in secured corporate environments as well. The individual is initially provided with a security bracelet at the security desk. The bracelet will identify the individual as well as the levels of permissions that the wearer is granted. This allows the wearer access only to those areas that they have clearance. Also, the whereabouts of the wearer can be tracked and monitored throughout the buildings. This bracelet may also be used as a form of time card as well as a security badge. Once the bracelet has been disabled, the wearer is no longer on the clock.

In another preferred embodiment of a security system of the present invention, the system provides a double door lock to prevent unauthorized entry into the cockpit of an airliner or other secure area. Even if the first door is opened by an unauthorized individual, the second door must be opened by another person after physically identifying the individual.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1 A security system, comprising:
a wrist bracelet, said wrist bracelet including means for storing individualized identification data and means for communicating said data;
a baggage tag, said baggage tag including means for storing individualized baggage identification data;
a data entry terminal including means for entering said individualized identification data in said means for storing individualized identification data of said wrist bracelet;
a database operatively connected to said data entry terminal, said database including means for storing flight data, passenger data, employee data, baggage data, and facility data;
a control system operatively connected to said database and said data entry terminal;
a communication link operatively connected to said control system;
one or more doors; each of said doors including a sensor operatively associated with said communication link for detecting said individualized identification data associated with said wrist bracelet, and each of said doors further including selectively actuated locking means responsive to a signal from said control system through said communication link to selectively lock or unlock said doors in response to validation of said individualized identification data associated with said wrist bracelet; and
each of said doors including a sensor operatively associated with said communication link for detecting said individualized baggage identification data, and each of said doors further including selectively actuated locking means responsive to a signal from said control system through said communication link to selectively lock or unlock said doors in response to validation of said individualized baggage identification data associated with said baggage tag.

2 In an airport security system, the combination comprising:
a wrist bracelet, said wrist bracelet including means for storing individualized identification data and means for communicating said data;
a baggage tag, said baggage tag including means for storing individualized baggage identification data; and
a data entry terminal including means for entering said individualized identification data in said means for storing individualized identification data of said wrist bracelet.

3 The combination of claim 2, further comprising a database operatively connected to said data entry terminal, said database including means for storing flight data, passenger data, employee data, baggage data, and facility data.

4 The combination of claim 3, further comprising a control system operatively connected to said database and said data entry terminal.

5 The combination of claim 4, further comprising a communication link operatively connected to said control system.

6 The combination of claim 5, further comprising concourse doors, gate doors, baggage claim area doors, boarding doors, airplane doors, cockpit doors, and overhead baggage compartment doors, each of said doors including a sensor operatively associated with said communication link for detecting said individualized identification data associated with said wrist bracelet.

7 The combination of claim 6, wherein each of said doors further include selectively actuated locking means responsive to a signal from said control system through said communication link to selectively lock or unlock said doors in response to validation of said individualized identification data associated with said wrist bracelet.

8 The combination of claim 6, wherein said baggage claim doors and said overhead baggage compartment doors each include a sensor operatively associated with said communication link for detecting said individualized baggage identification data, and each of said baggage claim and overhead compartment doors further including selectively actuated locking means responsive to a signal from said control system through said communication link to selectively lock or unlock said doors in response to validation of said individualized baggage identification data associated with said baggage tag.

9 The combination of claim 1 wherein said system includes:
time sensitive mechanism for limiting the time that said wrist bracelet is effective.

10 The combination of claim 2, further comprising a travel pack target marketed to selected passengers on the basis of said individualized identification data, said travel pack including items for use by children traveling with one or more adult passengers so as to minimize the need for carryon items.

11 The combination of claim 10, wherein said travel pack includes items selected from the group consisting of a bib, a snack, a toy, disposable diapers, wipes, ointment, and a toy.

12 The combination of claim 10, wherein said travel pack is customized dependent upon said individualized identification data so as to be age and sex appropriate for a particular child.

13 The system of claim 1 wherein said wrist bracelet includes:
an interior security strip; and
individualized identification data is retrievable from said interior security strip.

14 In an airport security system, the combination comprising:
at least one wrist bracelet including means for individually identifying a passenger;
at least one baggage tag including means for individually identifying a bag; and
means for selectively precluding access of at least one of said bag and said passenger from preselected areas.

15 The combination of claim 14, further comprising means for selectively allowing access of at least one of said bag and said passenger to predetermined areas.

16 The combination of claim 15, wherein said means for selectively allowing access permit a passenger to leave a baggage claim area only with the passenger's own bags.

17 The combination of claim 15, wherein said means for selectively allowing access permit a passenger to enter only a concourse associated with the passenger's flight.

18 The combination of claim 15, wherein said means for selectively allowing access permit a passenger to enter only a gate associated with the passenger's flight.

19 The combination of claim 15, wherein said means for selectively allowing access permit a passenger to enter only a plane associated with the passenger's flight.

20 The combination of claim 15, wherein said means for selectively allowing access permit a child to leave a predetermined area only with a parent or guardian.

21 The combination of claim 15, wherein said means for selectively allowing access permit a passenger to access only overhead baggage storage area associated with the passenger's assigned seat.

22 The system of claim 14 wherein said wrist bracelet includes:
an interior security strip; and
individualized identification data is retrievable from said interior security strip.

23 In an airport security system, the combination comprising:
at least one wrist bracelet including means for individually identifying an employee; and
means for selectively permitting said employee access to only predetermined areas.

24 The combination of claim 23, wherein said means for selectively permitting access permits access to only predetermined concourses.

25 The combination of claim 23, wherein said means for selectively permitting access permits access to only predetermined gates.

26 The combination of claim 23, wherein said means for selectively permitting access permits access to only predetermined flights.

27 In an airport security system, a relational database including means for storing flight data, passenger data, employee data, baggage data, facility data, and means for relationally linking said data based upon predetermined criteria to determine permissions regulating passenger, baggage, and employee access to preselected gates, concourses, flights, and baggage claim areas.

28 The airport security system of claim 27, further comprising at lease one machine readable wrist bracelet for individually identifying an individual and associating said individual with corresponding data stored in said database.

29 The airport security system of claim 27, further comprising at lease one machine readable baggage tag for individually identifying a bag and associating said bag with corresponding data stored in said database.
